(19) United States
(12) Patent Application Publication
(10) Pub. No.: US 2014/0176595 A1
(43) Pub. Date: Jun. 26, 2014

(54) IMAGE PROCESSING DEVICE AND METHOD THEREOF

(71) Applicant: SAMSUNG DISPLAY CO., LTD., Yongin-City (KR)

(72) Inventors: Seiki TAKAHASHI, Yokohama (JP); Hiroshi OHISHI, Yokohama (JP)

(73) Assignee: SAMSUNG DISPLAY CO., LTD., Yongin-City (KR)

(21) Appl. No.: 14/135,898

(22) Filed: Dec. 20, 2013

(30) Foreign Application Priority Data
Dec. 21, 2012 (JP) 2012-280312

(51) Int. Cl. G09G 5/02

(52) U.S. Cl. CPC G09G 5/02
USPC 345/590

(57) ABSTRACT

A image processing method converts an input signal to a first image signal of a first color gamut, converts a second color gamut to a second image signal for expression in an image output device having the first color gamut, determines a blend coefficient for defining a synthesis ratio of the first and second image signals, and synthesizes the first and second image signals using a ratio based on the blend coefficient to generate a synthesis image signal. The blend coefficient may be based on a value V and a saturation S obtained from the input signal. A color synthesis unit synthesizes the first and second image signals using a ratio according to the determined blend coefficient.

### CROSS-REFERENCE TO RELATED APPLICATION

Japanese Patent Application No. 2012-280312, filed on Dec. 21, 2012, and entitled, “Image Processing Device and Method Thereof,” is incorporated by reference herein in its entirety.

### BACKGROUND

1. Field

One or more embodiments described herein relate to image processing.

2. Description of the Related Art

Color expression techniques may be used to enlarge a color reproduction domain of a display. The enlargement may be performed in attempt to satisfy international display standards. These standards provide for a wider color gamut as compared with sRGB or Adobe® RGB standards.

For example, UHDTV color standards may be defined in UHDTV international standards (RECOMMENDATION ITU-R BT. 2020: Parameter values for UHDTV systems for production and international program exchange). In a broadcast application, when a signal corresponding to a wide color gamut is provided to a display having a narrow color gamut, color from the wide color gamut must be converted to the narrow color gamut of the display in order to achieve a quality output.

A variety of methods have been proposed for converting color from a wide color gamut to a narrow color gamut. One method calculates hue H, saturation S, and value V, synthesizes an input data value, and uses a data value obtained by performing color gamut conversion on the input data value to generate output data. However, this and other methods have proven to be inaccurate and unreliable.

### SUMMARY

In accordance with one embodiment, an image processing device includes a signal input unit configured to convert an input signal indicating an image to a first image signal of a first color gamut, the first image signal being linear; a color gamut conversion unit configured to convert a second color gamut to a second image signal for expression in an image output device having the first color gamut, the second color gamut being wider than the first color gamut; a blend coefficient deciding unit configured to determine a blend coefficient for defining a synthesis ratio of the first image signal and the second image signal based on a value V and a saturation S obtained from the input signal; and a color synthesis unit configured to synthesize the first and second image signals using a ratio based on the blend coefficient to generate a synthesis image signal.

The blend coefficient deciding unit may perform inverse conversion on the second image signal corresponding to a boundary of a color gamut; obtain a boundary value for value V and a boundary value for saturation S corresponding to a non-overflow condition, wherein an overflow condition corresponds to a state where the synthesis image signal is not included in a range between 0 to 1, determine a first blend coefficient when the value V is more than the boundary value for V or the saturation is more than the boundary value for S, and determine a second blend coefficient when the value V is less than the boundary value of V and the saturation is less than the boundary value for S, the second blend coefficient being greater than the first blend coefficient and less than 1.

The second blend coefficient may vary within a range between 0 and 1 based on a linear function, an exponential function, or a sigmoid function according to the value of value V or saturation S.

In accordance with another embodiment, an image processing device includes a signal input unit configured to convert an input signal indicating an image to a first image signal of a first color gamut, the first image signal being linear, a color gamut conversion unit configured to convert a second color gamut to a second image signal for expression in an image output device having the first color gamut, the second color gamut being wider than the first color gamut, a blend coefficient deciding unit configured to determine a blend coefficient for defining a synthesis ratio of the first image signal and the second image signal, and a color synthesis unit configured to synthesize the first and second image signals according to a ratio based on the blend coefficient to generate a synthesis image signal.

The blend coefficient deciding unit may determine an overflow condition directly from the second image signal, determine a first blend coefficient when the overflow condition is generated, and determine a second blend coefficient which is greater than the first blend coefficient and less than 1 when the overflow condition is not generated.

The second blend coefficient may vary in a range between 0 and 1 when the synthesis image signal has a value corresponding to a non-overflow condition, and the second blend coefficient may vary in the range between 0 and 1 based on a knee function, a linear function, a exponential function, or a sigmoid function according to a V value or a saturation S. The first blend coefficient may be determined such that the synthesis image signal becomes the first image signal.

The second blend coefficient may be determined such that the synthesis image signal becomes the second image signal or corresponds to a result obtained by blending the first and second image signals.

In accordance with another embodiment, an image processing method includes converting an input signal indicating an image to a first image signal of a first color gamut, the first image signal being linear; converting a second color gamut to a second image signal for expression in an image output device having the first color gamut, the second color gamut being wider than the first color gamut; determining a blend coefficient for defining a synthesis ratio of the first image signal and second image signal based on a value V and a saturation S obtained from the input signal; and synthesizing the first and second image signals using a ratio based on the blend coefficient to generate a synthesis image signal.

The blend coefficient comprises may be determined by performing inverse conversion from the first image signal to the second image signal corresponding to a boundary of a color gamut, obtaining a first boundary value of V and a first boundary value of S corresponding to a non-overflow condition, an overflow condition indicating a state where the synthesis image signal is not included in a range between 0 to 1, determining a first blend coefficient when value V is greater than the first boundary value of V or saturation S is greater than the first boundary value of S, and determining a second blend coefficient when value V is less than the first boundary value of V and saturation is less than the first boundary value S, the second blend coefficient being greater than the first blend coefficient and less than 1.

The blend coefficient may be determined by determining a second boundary value for V and a second boundary value for S, determining the second boundary value for V includes setting the first boundary value for V to a predetermined value, and setting the first boundary value of S to an initial saturation boundary value for each hue varied between 0° and 360°, calculating a second synthesis image signal using the first blend coefficient and second blend coefficient, the second synthesis image signal calculated by varying V from 0 to 1 at each value boundary, an initial boundary value of V being increased by a constant interval, setting a boundary value for V immediately before overflow to the second value boundary value, when the second synthesis image signal is determined to corresponding to an overflow condition, and setting a value of 1 to the second boundary value of V when the second synthesis image signal corresponds to a non-overflow condition.

Determining the second boundary value for S may include setting the second boundary value for V to a predetermined value and the first boundary value for S to an initial saturation boundary value for each hue varied between 0° and 360°, calculating a third synthesis image signal using the first blend coefficient and the second blend coefficient, the third synthesis image signal calculated by varying a value from 0 to 1 at each boundary S, an initial boundary value for S being increased by a constant interval, setting a boundary value for S immediately before overflow to the second boundary value for S when the third synthesis image signal is determined to correspond to an overflow condition, and setting a value of 1 to the second boundary value of S when the third synthesis image signal is determined to correspond to a non-overflow condition.

In accordance with another embodiment, an image processing method includes converting an input signal indicating an image to a first image signal of a first color gamut, the first image signal being linear, converting a second color gamut to a second image signal for expression in an image output device having the first color gamut, the second color gamut wider than the first color gamut, determining a blend coefficient for defining a synthesis ratio of the first image signal and the second image signal, and synthesizing the first and second image signals using a ratio based on the blend coefficient to generate a synthesis image signal.

The blend coefficient may be determined by determining an overflow condition directly from the second image signal, determining a first blend coefficient corresponding to an overflow condition, and determining a second blend coefficient corresponding to a non-overflow condition, the second blend coefficient being more than the first blend coefficient and less than 1.

In accordance with another embodiment, an image processing method includes converting an input signal to a first image signal of a first color gamut, converting a second color gamut to a second image signal for expression in an image output device having the first color gamut, determining a blend coefficient for defining a synthesis ratio of the first and second image signals, the blend coefficient based on a value V and a saturation S obtained from the input signal, and synthesizing the first and second image signals using a ratio based on the blend coefficient to generate a synthesis image signal.

The blend coefficient may be determined by performing an inverse conversion from the first image signal to the second image signal corresponding to a boundary of a color gamut wider than the first color gamut, obtaining a first boundary value of V and a first boundary value of S corresponding to a non-overflow condition, determining the blend coefficient as a first blend coefficient when value V is greater than the first boundary value of V or saturation S is greater than the first boundary value of S, and determining the blend coefficient as a second blend coefficient when value V is less than the first boundary value of V and saturation is less than the first boundary value S, the second blend coefficient being greater than the first blend coefficient and less than 1. The first image signal may be linear.

The second color gamut may be wider than the first color gamut. The wide color gamut may correspond to the second color gamut. The overflow condition may correspond to a state where the synthesis image signal is not included in a predetermined range. The predetermined range may include values between 0 and 1.

The blend coefficient may be determined by determining an overflow condition from the second image signal, determining the blend coefficient to be a first blend coefficient corresponding to an overflow condition, and determining the blend coefficient to be a second blend coefficient corresponding to a non-overflow condition, the second blend coefficient being greater than the first blend coefficient and less than a predetermined value. The predetermined value may be 1.

Determining the blend coefficient may includes determining a second boundary value for V and a second boundary value for S. Determining the second boundary value for V may includes setting the first boundary value for V to a predetermined value, and setting the first boundary value of S to an initial saturation boundary value for each hue varied between 0° and 360°, calculating a second synthesis image signal using the first blend coefficient and second blend coefficient, the second synthesis image signal calculated by varying V from 0 to 1 at each value boundary, an initial boundary value of V being increased by a constant interval, setting a boundary value for V immediately before overflow to the second value boundary value, when the second synthesis image signal is determined to corresponding to an overflow condition, and setting a value of 1 to the second boundary value of V when the second synthesis image signal corresponds to a non-overflow condition.

Determining the second boundary value for S may include setting the second boundary value for V to a predetermined value and the first boundary value for S to an initial saturation boundary value for each hue varied between 0° and 360°, calculating a third synthesis image signal using the first blend coefficient and the second blend coefficient, the third synthesis image signal calculated by varying a value from 0 to 1 at each boundary S, an initial boundary value for S being increased by a constant interval, setting a boundary value for S immediately before overflow to the second boundary value for S when the third synthesis image signal is determined to correspond to an overflow condition, and setting a value of 1 to the second boundary value of S when the third synthesis image signal is determined to correspond to a non-overflow condition.

### BRIEF DESCRIPTION OF THE DRAWINGS

Features will become apparent to those of ordinary skill in the art by describing in detail exemplary embodiments with reference to the attached drawings in which:

FIG. 1 illustrates an embodiment of an image processing device;

FIG. 2 illustrates a color gamut difference between UHDTV and Adobe RGB;

FIG. 3 illustrates color gamut boundary points in an S-V coordinate system for wide (UHDTV) and narrow (Adobe RGB) color gamuts;

FIG. 4 illustrates color gamut boundary points in an H-S coordinate system for wide (UHDTV) and narrow (Adobe RGB) color gamuts;

FIG. 5 illustrates a blend level set based on a exponential function when saturation is less than a critical point;

FIG. 6 illustrates a blend level set based on a linear function for less than critical point values;

FIG. 7 illustrates a blend level set based on a linear function when saturation is less than a critical point;

FIG. 8 illustrates a blend level set based on a sigmoid function when saturation is less than a critical point;

FIG. 9 illustrates an embodiment of a method for determining a critical value for avoiding overflow;

FIG. 10 illustrates another embodiment of a method for determining a critical value for avoiding overflow;

FIG. 11 illustrates color gamut boundary points on an H-S coordinate system in a wide color gamut (UHDTV) and a narrow color gamut (Adobe RGB) according to another embodiment;

FIG. 12 illustrates another embodiment of an image processing device;

FIG. 13 illustrates a relationship between a blend coefficient α and Min(Vi′, 1−Vi′) using a knee function when blend level is adjusted by a parameter k;

FIG. 14 illustrates a relationship of a blend coefficient α and Min(Vi′, 1−Vi′) using a exponential function when blend level is adjusted by a parameter β; and

FIG. 15 illustrates relationship of a blend coefficient α and Min(Vi′, 1−Vi′) using a linear function when blend level is adjusted by a parameter x1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

### First Embodiment

A first embodiment relates to a technique of deciding a blend coefficient after searching how RGB data input such a condition that an image signal after color conversion corresponds to a boundary of a color gamut is distributed at an HSV color space under, in order to clarify how to set a blend coefficient according to a hue H, a saturation S, and a value V without generation of overflow.

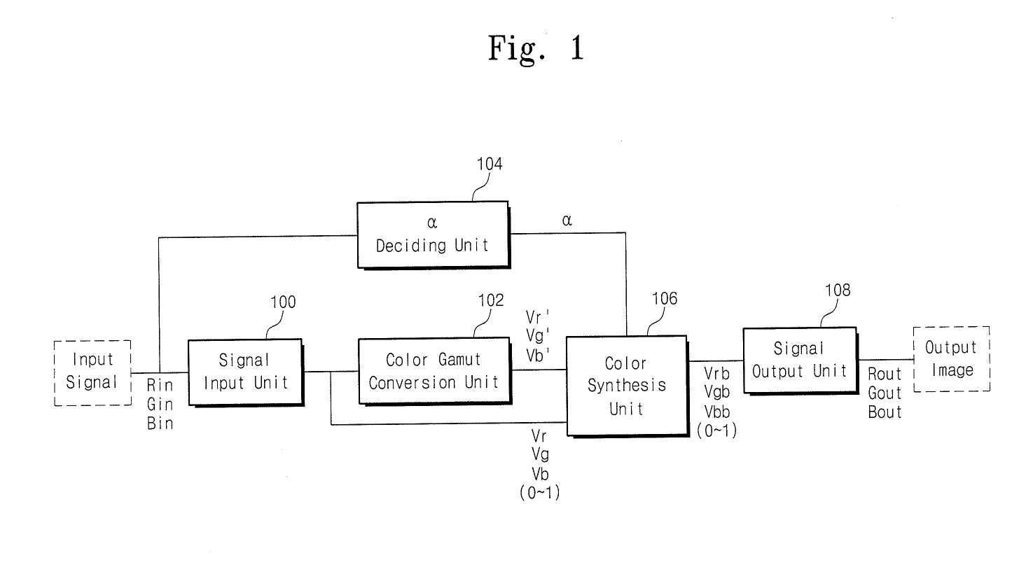

FIG. 1 illustrates a first embodiment of an image processing device which includes a signal input unit 100, a color gamut conversion unit 102, a blend coefficient deciding unit (α deciding unit) 104, a synthesis unit 106, and a signal output unit 108.

The signal input unit 100 may receive a signal (e.g., input signals Rin, Gin, and Bin) indicating an image. The signal input unit 100 may standardize the input signals Rin, Gin, and Bin between predetermined values, e.g., 0 and 1. The signal input unit 100 may perform power conversion on the standardized signals to generate linear image data Vr, Vg, and Vb. For example, in the event that an input signal has the sRGB standard, a gamma (γ) value may be 2.2. Thus, the linear image data Vr, Vg, and Vb may be generated through a power of 2.2.

The color gamut conversion unit 102 may convert the image signals Vr, Vg, and Vb generated by the signal input unit 100 into an image signal of a narrow color gamut using a conversion matrix. For example, the conversion may be from a UHDTV color gamut to an Adobe RGB color gamut. In other embodiments, conversion between different standards may be performed. In one application, the color gamut conversion unit 102 perform a calculation for expression of an image having a wide color gamut standard in a narrow color gamut image output device using a conversion matrix. The color gamut conversion unit 102 may generate image signals Vr′, Vg′, and Vb′ as a conversion result.

The blend coefficient deciding unit 104 may decide a blend coefficient α based on a value H and a saturation S, obtained from input signals Rin, Gin, and Bin, to prevent overflow corresponding, for example, to a state where a synthesis image signal is not included in a range between 0 and 1. The blend coefficient α may define a synthesis ratio of image signals Vr, Vg, and Vb and image signals Vr′, Vg′, and Vb′ synthesized by the color synthesis unit 106. For example, in the synthesis ratio, if the blend coefficient α is 1, the image signals Vr′, Vg′, and Vb′ may be 100%. If the blend coefficient α is 0, the image signals Vr, Vg, and Vb may be 100%.

The blend coefficient deciding unit 104 may decide a blend coefficient after searching how RGB data, input under a condition where image signals Vr′, Vg′, and Vb′ after color conversion corresponds to a boundary of a color gamut, is distributed within an HSV color space. The narrow color gamut image output device may calculate an HSV value by performing inverse conversion of a conversion matrix for expression of a wide color gamut, performing power conversion, and obtaining R, G and B data.

Additionally, a value V and a saturation S for avoiding overflow may be defined. The blend coefficient α may be set differently based on whether the V value and/or saturation S exceed a predetermined value or not. In accordance with one embodiment, the value V may correspond to lightness or brightness. If the value V or saturation S exceed the predetermined value, the blend coefficient α may be set to 0 (α=0). If a value V or saturation S are less than the specified value, the blend coefficient α may be set to a value between 0 and 1.

When saturation S and the V value are less than specified values S1 and V1 for avoiding overflow, the blend coefficient deciding unit 104 may set the blend coefficient α using a function that changes blend coefficient α to between 0 and 1. For example, considering a relationship between saturation S and blend coefficient α, an α value less than S1 may be decided using a exponential function, a linear function, or a sigmoid function. Also, considering a relationship between the value V and the blend coefficient α, α value less than V1 may be decided using a linear function.

The color synthesis unit 106 may synthesize image signals Vr, Vg, and Vb generated by the signal input unit 100 and image signals Vr′, Vg′, and Vb′ generated by the color gamut conversion unit 102 using a synthesis ratio. The synthesis ratio may be based on the blend coefficient α decided by the blend coefficient deciding unit 104. In one embodiment, α may be set to a small value when overflow of the image signals Vr′, Vg′, and Vb′ is generated, and may be set to a large value when overflow of the image signals Vr′, Vg′, and Vb′ does not occur. The color synthesis unit 106 may generate synthesized image signals Vrb, Vgb, and Vbb.

The signal output unit 108 may perform power conversion on image signals Vrb, Vgb, and Vbb after synthesis to generate output signals Rin, Gin, and Bin. For example, Rout, Gout, and Bout having a required number of bits may be generated through a power ratio of 1/2.2. The output signals Rout, Gout, and Bout may be output to an image output device such as a display, a projector, a printer, etc.

With the image processing device including the blend coefficient deciding unit 104, an image may be expressed with a natural tone. The image may be expressed in this tone even though image data having the wide color gamut standard is output to a device having a narrow color gamut.

An embodiment of an image processing method will now be discussed. This method includes obtaining standardized input signals Rin, Gin, and Bin between 0 and 1. Linear image signals Vr, Vg, and Vb may be generated by power conversion on a signal after standardizing. For example, if a gamma value γ of an input signal is 2.2, input signals Rin, Gin, and Bin may be divided and standardized by a level width according to the number of bits, a power of 2.2 may be performed, and linear image signals Vr, Vg, and Vb may be generated. The linear image signals Vr, Vg, and Vb may be expressed by equation (1) in case of an 8-bit level width.

$$( \begin{matrix}vr \\ vg \\ vb\end{matrix} ) = ( \begin{matrix}{( Rin / 255 )}^{γ} \\ {( Gin / 255 )}^{γ} \\ {( Bin / 255 )}^{γ}\end{matrix} ) \qquad ( 1 )$$

Then, after color conversion, image signals Vr′, Vg′, and Vb′ may be calculated from image signals Vr, Vg, and Vb. Here, a conversion matrix [Mc] for expression of a wide color gamut of a narrow color gamut image output device may be obtained from equations (2) and (3).

$$\begin{matrix}( \begin{matrix}X \\ Y \\ Z\end{matrix} ) = [ Mwc ] ( \begin{matrix}Vr \\ Vg \\ Vb\end{matrix} ) = [ Mnc ] ( \begin{matrix}{Vr}^{′} \\ {Vg}^{′} \\ {Vb}^{′}\end{matrix} ) & ( 2 ) \\ ( \begin{matrix}{Vr}^{′} \\ {Vg}^{′} \\ {Vb}^{′}\end{matrix} ) = {[ Mnc ]}^{- 1} [ Mwc ] ( \begin{matrix}Vr \\ Vg \\ Vb\end{matrix} ) = [ Mc ] ( \begin{matrix}Vr \\ Vg \\ Vb\end{matrix} ) & ( 3 )\end{matrix}$$

In these equations, [Mnc] indicates a conversion matrix of a wide color gamut, and [Mwc] indicates a conversion matrix of a narrow color gamut. Also, [Mc]=[Mwc]−1 [Mnc].

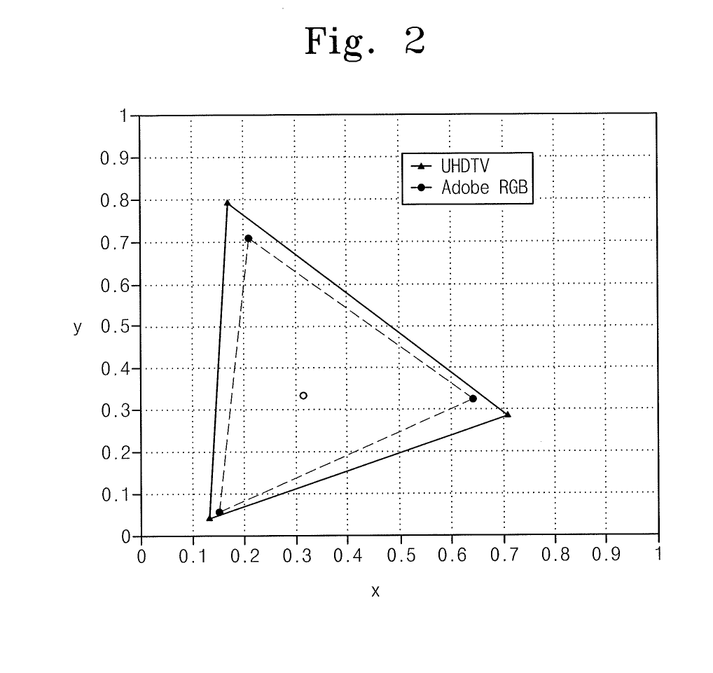

In the following discussion a case will be described where a wide color gamut is the RECOMMENDATION ITU-R BT. 2020 standard and the narrow color gamut is an Adobe RGB color gamut. Also, Table 1 may show CIE xy coordinate values of UHDTV and Adobe RGB, and a result obtained by plotting them by a CIE xy chromaticity diagram, as illustrated in FIG. 2. White may be the same D65. As understood from FIG. 2, a color gamut of UHDTV may be wider than Adobe RGB.

In exemplary embodiments, a case where a coordinate value of at least one point of R, G, and B values exists within a coordinate of the wide color gamut may be defined as a narrow color gamut. This may occur in a narrow color gamut on a wide color gamut, when plotting is made using CIE xy coordinates or CIE xy chromaticity diagram.

For example, as understood from the CIE xy chromaticity diagram, such a case that chromaticity coordinates corresponding to ‘R’ and ‘G’ exist, in UHDTV although a chromaticity coordinate corresponding to ‘B’ on an RGB plot of UHDTV exists at the outside of UHDTV, may be viewed as a narrow color gamut.

TABLE 1
CIE xy coordinate values of UHDTV and Adobe RGB

| | |
|---|---|
| UHDTV | Adobe RGB |

| | x | y | x | y |
|---|---|---|---|---|
| R | 0.708 | 0.292 | 0.640 | 0.330 |
| G | 0.170 | 0.797 | 0.210 | 0.710 |
| B | 0.131 | 0.046 | 0.150 | 0.060 |
| W | 0.3127 | 0.329 | 0.3127 | 0.329 |

Table 2-4 show examples of conversion matrixes of Adobe RGB and UHDTV and [Mc] values of equation (3).

TABLE 2
[Mwc]: conversion matrix of UHDTV

| | | |
|---|---|---|
| 0.6361 | 0.1450 | 0.1694 |
| 0.2624 | 0.6785 | 0.0592 |
| 0.0001 | 0.0284 | 1.0606 |

TABLE 3
[Mnc]: conversion matrix of Adobe RGB

| | | |
|---|---|---|
| 0.5767 | 0.1856 | 0.1882 |
| 0.2973 | 0.6274 | 0.0753 |
| 0.0270 | 0.0707 | 0.9913 |

TABLE 4
[Mnc] = [Mwc]⁻¹ [Mnc]

| | | |
|---|---|---|
| 1.1503 | −0.0971 | −0.0532 |
| −0.1243 | 1.1334 | −0.0091 |
| −0.0224 | −0.0496 | 1.0720 |

Synthesis image signals Vrb, Vgb, and Vbb may be generated by blending the obtained image signals Vr, Vg, and Vb and the obtained image signals Vr′, Vg′, and Vb′ using a blend coefficient α. The synthesis image signals Vrb, Vgb, and Vbb may be obtained from equations (4) to (6).

Vrb=(1−α)Vr+αVr′ (4)

Vgb=(1−α)Vg+αVg′ (5)

Vbb=(1−α)Vb+αVb′ (6)

The synthesis image signals Vrb, Vgb, and Vbb may be converted into output signals Rout, Gout, and Bout according a required bit number through power conversion. For example, the output signals Rout, Gout, and Bout according a required bit number may be generated through a power of 2.2. The following equation (7) may show an 8-bit case.

$$( \begin{matrix}Rout \\ Gout \\ Bout\end{matrix} ) = ( \begin{matrix}255 {( Vrb )}^{1 / γ} \\ 255 {( Vgb )}^{1 / γ} \\ 255 {( Vbb )}^{1 / γ}\end{matrix} ) \qquad ( 7 )$$

When signal conversion is performed to display an image, by providing a wide color gamut of image signal to an image output device such as a narrow color gamut display, image signals Vr′, Vg′, and Vb′ may be generated after conversion have been performed for values less than 1 or more than 1. That is, since the conversion matrix [Mc] in the Table 4 includes values less than 0 or more than 1, the likelihood exists that image signals Vr′, Vg′, and Vb′ obtained using the conversion matrix [Mc] may become less than 0 or more than 1.

As a result, the synthesis image signals Vrb, Vgb, and Vbb may be generated to have values less than 0 or more than 1. This may be referred to as overflow. If overflow is generated during circuit operation, the case that data is less than 0 may be fixed to 0, and the case that data is more than 1 may be fixed to 1. Since an image signal being converted has the same value, it is impossible to display the image signal accurately.

To avoid such a problem, the value of blend coefficient α may be set to a small value when overflow on the image signals Vr′, Vg′, and Vb′ is generated. To perform color conversion into a wide color gamut efficiently, a value of blend coefficient α may be set to a large value, as far as possible.

The blend coefficient α may be decided based on a value V and a saturation S, which are capable of being obtained from input signals Rin, Gin, and Bin. Also, a hue H, a saturation S, and a value V may be obtained from RGB data of the input signals through the following equations (8) to (10).

$$\begin{matrix}\begin{matrix}H = 60 \frac{G - B}{Max - Min} & if Max = R or \\ H = 60 \frac{B - R}{Max - Min} + 120 & if Max = G or \\ H = 60 \frac{R - G}{Max - Min} + 240 & if Max = B\end{matrix} & ( 8 ) \\ S = \frac{Max - Min}{Max} & ( 9 ) \\ V = Max & ( 10 )\end{matrix}$$

To determine the blend coefficient α, first, a search may be performed to determine an overflow condition for signals Vr′, Vg′, and Vb′ after color conversion. This search may be performed to determine an overflow condition for synthesis image signals Vrb, Vgb, and Vbb. This may involve determining how RGB data is distributed in an HSV color space, for RGB data input when image signals Vr′, Vg′, and Vb′, after conversion, correspond to a boundary of a color gamut.

First, a search may be performed for a condition where one of image signals Vr′, Vg′, and Vb′, after conversion, is less than 0 or more than 1 and where the remaining image signals have any value. For example, the remaining image signals may have any one of six values selected for a 150-condition. The six value may be, for example, 0, 0.2, 0.4, 0.6, 0.8, or 1.0. In other embodiments a different number and/or different values may be selected for the 150-condition.

Next, image signals Vr, Vg, and Vb may be obtained by performing an inverse conversion operation, which may be expressed, for example, by equation (11).

$$( \begin{matrix}Vr \\ Vg \\ Vb\end{matrix} ) = {[ Mc ]}^{- 1} ( \begin{matrix}{Vr}^{′} \\ {Vg}^{′} \\ {Vb}^{′}\end{matrix} ) \qquad ( 11 )$$

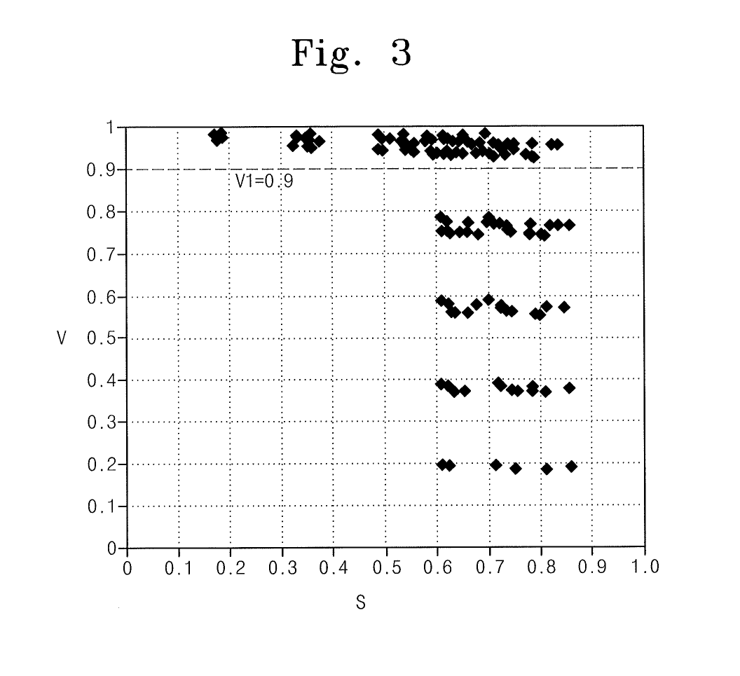

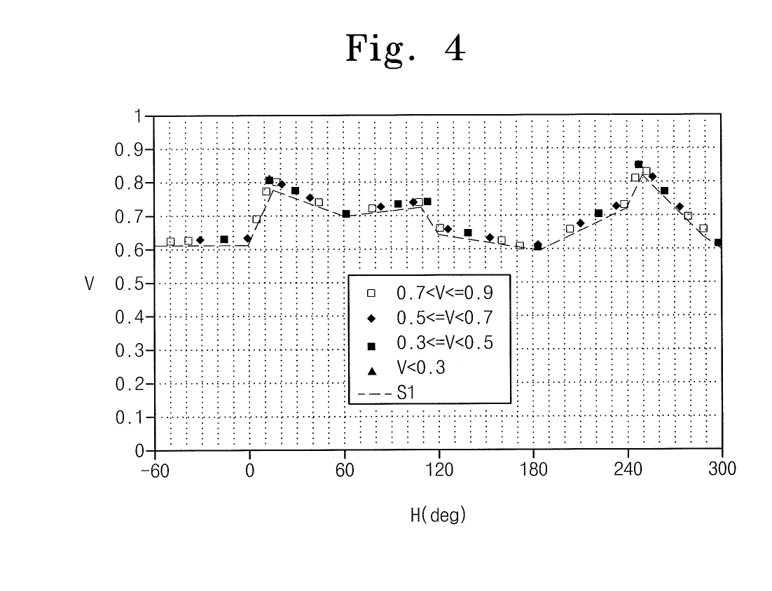

Next, the values of H, S, and V may be calculated by performing a power conversion of 1/γ=1/2.2 and obtaining R, G, and B values. A plot on an S-V coordinate system of a color gamut boundary for a 150-condition of a wide color gamut (UHDTV) and a narrow color gamut (Adobe RGB), thus obtained, is illustrated in FIG. 3. A plot on an H-S coordinate system is illustrated in FIG. 4. Also, a condition of V1>0.9 may be excluded from FIG. 4.

In FIGS. 3 and 4, a condition in which image signals Vr′, Vg′, and Vb′ corresponding to expression of a wide color gamut are not overflowed may be defined as a condition where a value V has a value less than 0.9 and a saturation value S is less than S1. Such a condition may correspond to a line connecting points (e.g., points downwards placed by S=0.01) of a color gamut boundary in FIG. 4. Here, V1 may indicate a boundary value of a value V capable of avoiding overflow, and S1 may indicate a boundary value of saturation S capable of avoiding overflow.

Thus, overflow of synthesis image signals Vrb, Vgb, and Vbb may be prevented by defining a blend coefficient α as follows.

when S≧S1 or V≧V1, α=0 (narrow color gamut expression) (a)

when S<S1 and V<V1, α=0˜1 (blend expression of wide color gamut expression and narrow color gamut expression) (b)

Also, a boundary of S1 may be obtained from a plot on the H-S coordinate system according to a condition of V<0.9 when V1 =0.9. However, it is possible to obtain the critical point of S1 from a plot on the H-S coordinate system according to a condition of V<Vo when V1=Vo.

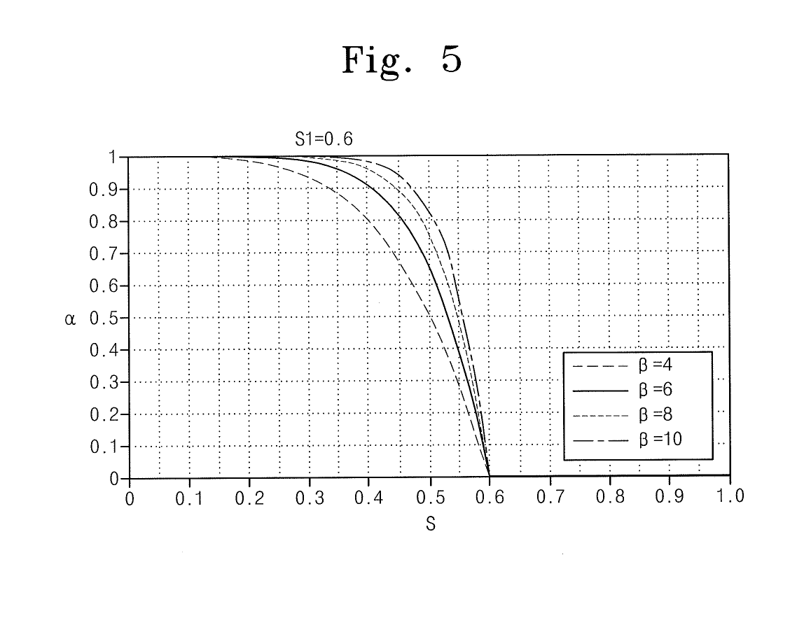

A relationship between (a) and (b) may be set as a exponential function to adjust a blend level using parameters as illustrated in FIG. 5 and equation (12). In equation (12), ‘β’ may be a coefficient. The larger the value of β, the stronger a level of color conversion into a wide color gamut. Also, S1 may be a value of S by which the blend coefficient α is set to 0.

$$S 1 < S \text{:} α = 1 - {( \frac{S}{S 1} )}^{β} , \\ S \geq S 1 \text{:} α = 0 \qquad ( 12 )$$

FIG. 5 illustrates an embodiment where S1 is set to 0.6 (S1=0.6). As understood from FIG. 5, when saturation S has a value less than 0.6, a value of the blend coefficient α may increase exponentially and may be saturated to 1 at a domain where the value of saturation S is small, which, for example, may be a predetermined value. At this time, it is possible to adjust an increment of the blend coefficient α by adjusting a value of β.

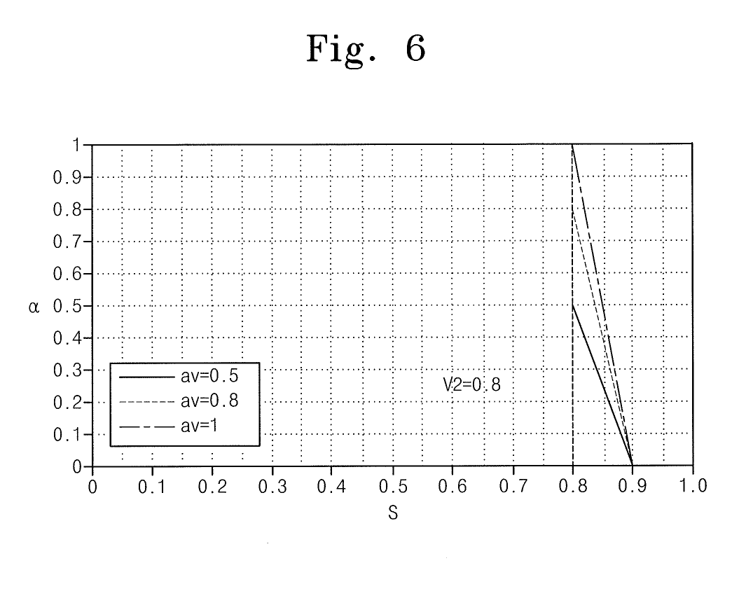

A relationship between the blend coefficient α and value V may be set using a linear function to adjusting a blend level using a parameter V2 as illustrated in FIG. 6 and equation (13). In equation (13), V2 may be a blend start value associated with the value V. In exemplary embodiments, V2 may be set to V1−0.1 (V2=V1−0.1). The larger the value of V2, the stronger the level of color conversion into a wide color gamut. FIG. 6 also shows the blend coefficient α when V<V2 is determined to be a blend condition associated with saturation S.

$$V 2 \leq V < V 1 \text{:} α = α v \frac{V 1 - V}{V 1 - V 2} , \\ V \geq V 1 \text{:} α = 0 \qquad ( 13 )$$

In equation (13), Sv2 ay be expressed by equation (14) for obtaining αv.

$$1 - \frac{Min ( R , G , B )}{V 2} < 0 \text{:} Sv 2 = 0 \\ 1 - \frac{Min ( R , G , B )}{V 2} \geq 0 \text{:} S v 2 = 1 - \frac{Min ( R , G , B )}{V 2} \qquad ( 14 )$$

FIG. 6 illustrates an embodiment where V1 is set to 0.9. As understood from FIG. 6, the value V may linearly increase in a range between V1 and V2, and a slope of this line may be adjusted by αv.

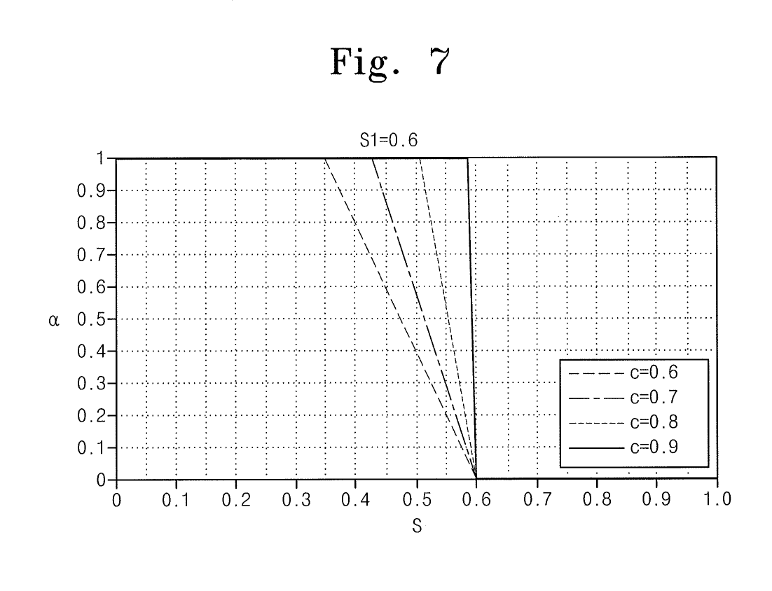

Also, a relationship between the blend coefficient α and saturation S may be set using a linear function, to adjust a blend level using parameter c illustrated in FIG. 7 and equations (15) and (16). In equation (16), a saturation value S2 by which α is set to 1 may be defined with respect to S1. As parameter c becomes larger when S2=cS1, color conversion into a wide color gamut may be strong.

$$\begin{matrix}S < S 2 \text{:} α = 1 \\ S 2 \leq S \leq S 1 \text{:} α = \frac{S 1 - S}{S 1 - S 2} \\ S \geq S 1 \text{:} α = 0 & ( 15 ) \\ S 2 = c \cdot S 1 & ( 16 )\end{matrix}$$

As understood from FIG. 7, if a value of c becomes larger, a straight line may sharply rise at a domain where S is less than 0.6, and color conversion into a wide color gamut may be strong.

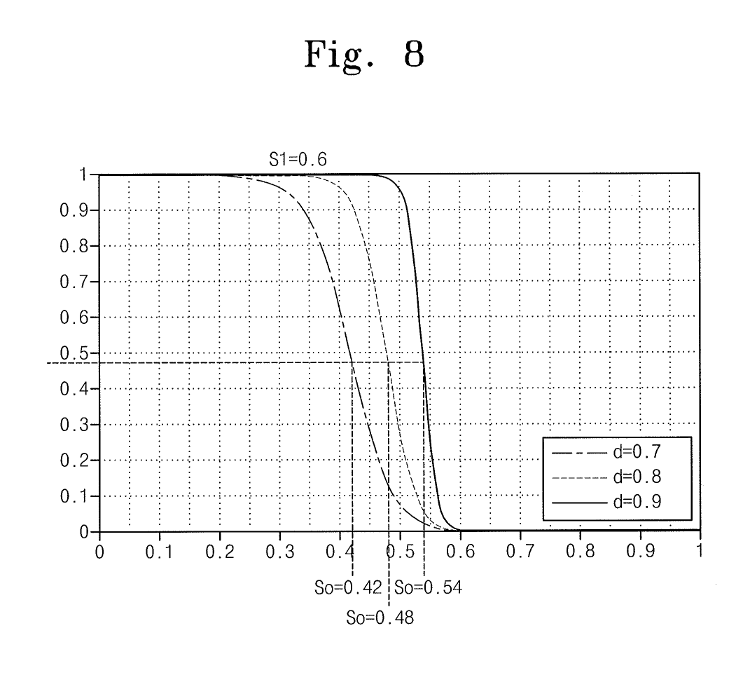

Also, in one embodiment, all linear functions may be replaced with a sigmoid function as illustrated in FIG. 8 based on equation (17). For example, as understood from equation (17), a relationship between the blend coefficient α and saturation S may be set using the sigmoid function. A parameter d in equation (17) may be set by So=d×S1, when the value of S=So when α is set to 0.5.

$$α = \frac{1}{1 + EXP ( \frac{a 0 ( S 1 - x 0 ) ( S - d \cdot S 1 )}{S ( 1 - d )} )} \qquad ( 17 )$$

For example, in equation (17), when S≧S1, parameters ao and xo may be respectively set to 85 and 0.54, such that α=0.

As illustrated in FIG. 8, in a domain where the blend coefficient α is varied from 0 to 1, a level of its variation (e.g., a gradient) may be changed by parameter d. Also, it is possible to vary the blend coefficient α continuously using the sigmoid function. In exemplary embodiments, a relationship among S, V, and α may be determined using a function. However, it is possible to use a lookup table when the circuit is actually designed.

In the event an image is displayed by performing color conversion on an image signal of a wide color gamut and providing a signal after color conversion to a narrow color gamut display, the manner in which the blend coefficient α may be determined may be clear. Accordingly, it is possible to prevent overflow with greater certainty, in order to maintain accurate display of an image and to realize color expression with high saturation close to a wide color gamut.

An image processing method in accordance with the first embodiment may be implemented in a program executed by a device such as a computer, central processing unit (CPU) embedded in a host device, or another type of processing circuit. The program may be stored in a computer readable storage medium, and/or may be provided through a communication network.

### Second Embodiment

The first embodiment relates to a technique of preventing overflow of synthesis image signals Vrb, Vgb, and Vbb, by setting a blend coefficient α to 0 when overflow of image signals Vr′, Vg′, and Vb′ correspond to wide color gamut expression. However, such a case may occur that no overflow is generated, even though at least one of, or both, the values of S1 and V1 is larger than a corresponding setting value. The second embodiment relates to a method of obtaining a critical point where overflow of synthesis image signals Vrb, Vgb, and Vbb is not generated.

In the second method, a method of obtaining the critical point where overflow of synthesis image signals Vrb, Vgb, and Vbb is not generated may include deciding the critical point of V1 (operation 1) and deciding the critical point of S1 (operation 2). Input data may use a test pattern where H, S, and V values are randomly changed and any still image.

In operation 1, while a hue H is changed from 0° to 360° at intervals of 1°, a saturation value S1 may be set to S1 as obtained in the first embodiment. Also, in each H, V1 may be set to V1 as obtained in the first embodiment. Then, while V1 is increased by Vs, S in each V1 condition is varied from 0 to 1 by Ss. Vrb, Vgb, and Vbb may be calculated by α as obtained in the first embodiment, and whether overflow is generated may be checked.

In the event that overflow is generated, (V1−Vs) may be set to the critical value of a corresponding H. In the event that overflow is not generated, V1 may be increased by Vs until the critical value of V1 is searched. In V1=1, if overflow of Vrb, Vgb, and Vbb is not generated, the critical value of V1 may be set to 1. Then, operation may be ended. The critical value of V1, thus obtained, may be referred to V1 of a new H interval (V1 of an intermediate H of 1° interval being obtained by linear interpolation).

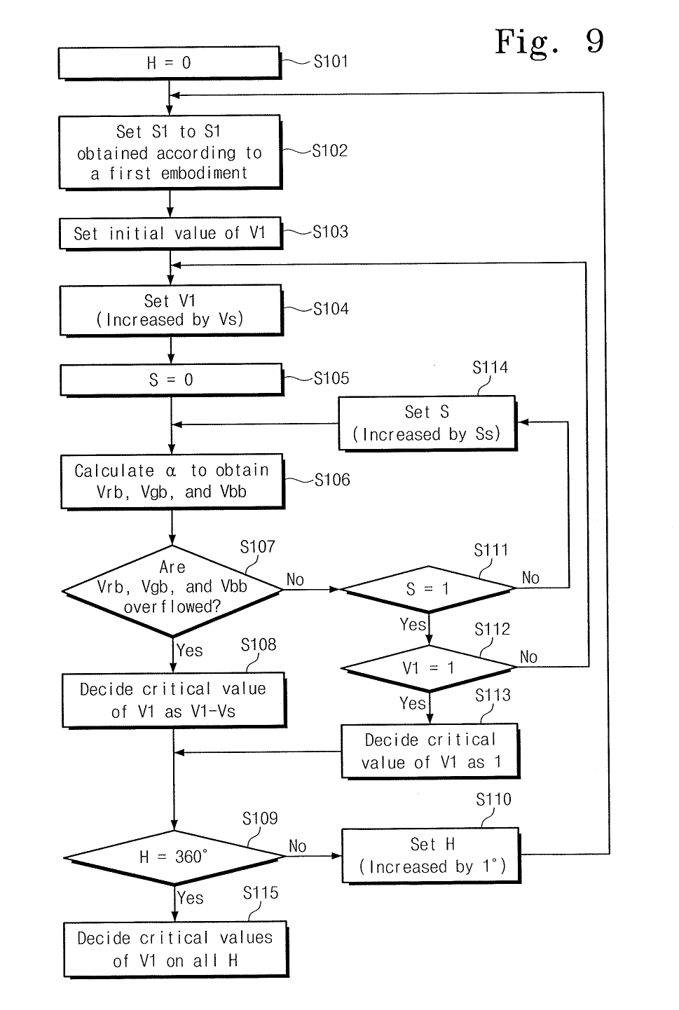

FIG. 9 illustrates operation 1 more fully. In FIG. 9, a value of hue H may be set to 0 (H=0) (S101), and a threshold value S1 associated with saturation S may be set to a value as obtained in the first embodiment (S102). A threshold value V1 associated with value V may be set to a value as obtained in the first embodiment (S103). A value of V1 may be increased by Vs (S104).

Then, a value of saturation S may be set to 0 (S=0) (S105). Synthesis image signals Vrb, Vgb, and Vbb may be calculated by a blend coefficient α as obtained in the first embodiment (S106). A determination may then be made as to whether synthesis image signals Vrb, Vgb, and Vbb, thus obtained, are overflowed (S107).

If an overflow of synthesis image signals Vrb, Vgb, and Vbb is generated, the critical value of V1 may be decided as (V1−Vs) (S108). Afterwards, whether hue H reaches 360° may be determined (S109). If not, a value of H may be increased by 1° (S110), and the method proceeds to S102 where a value of S1 is set. If so (H=360°), the critical values of V1 on all H may be decided (S115).

Returning to S107, if overflow is not generated, then whether the value of S is 1 may be determined (S111). If the value of S is not 1, the value of S may be increased by Ss (S114), and the method proceeds to S106 where synthesis image signals Vrb, Vgb, and Vbb are calculated. If the value of S is 1, whether the value of V1 is 1 may be determined (S112). If the value of V1 is not 1, the method proceeds to S104 where the value of V1 is increased by Vs. If the value of V1 is 1, the critical value of V1 may be determined as 1 (S113), and whether a value of H is 360° may be determined (S109).

As described above, the critical values of V1 on all H may be decided through the operation 1.

In operation 2, while hue H is changed from 0° to 360° at intervals of 1°, a saturation value V1 may be set to the critical value obtained through operation 1 (V232 V1−0.1). In each H, S1 may be set to S1 as obtained in the first embodiment. Then, while S1 is increased by Ss, V in each S1 condition is varied from 0 to 1 by Vs. Vrb, Vgb, and Vbb may then be calculated by α as obtained in the first embodiment, and whether overflow is generated may be checked.

In the event that overflow is generated, (S1−Ss) may be set to the critical value of a corresponding H. In the event that overflow is not generated, S1 may be increased by Ss until the critical value of S1 is searched. If overflow of Vrb, Vgb, and Vbb is not generated, the critical value of S1 may be set to 1. Then, operation may be ended. The critical value of S1, thus obtained, may be referred to S1 of a new H interval (S1 of an intermediate H of 1° interval being obtained by linear interpolation).

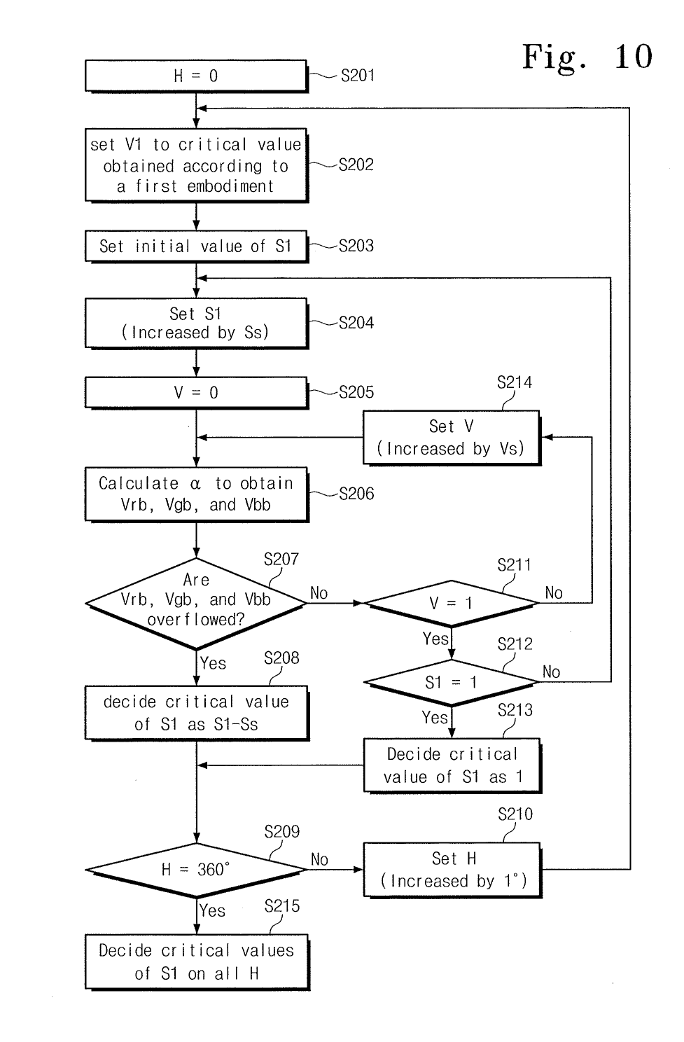

FIG. 10 more fully describes operation 2. A value of hue H may be set to 0 (H=0) (S201). A threshold value V1 associated with value V may be set to a value as obtained in operation 1 (S202). A threshold value S1 associated with saturation S may be set to a value as obtained in the first embodiment (S203). A value of S1 may be increased by Ss (S204).

Then, the value of V may be set to 0 (V=0) (S205). Synthesis image signals Vrb, Vgb, and Vbb may be calculated by a blend coefficient α as obtained in the first embodiment (S206). A determination is then made as to whether synthesis image signals Vrb, Vgb, and Vbb, thus obtained, are overflowed (S207).

If overflow of synthesis image signals Vrb, Vgb, and Vbb is generated, the critical value of S1 may be determined as (S1−Ss) (S208). Afterwards, whether hue H reaches 360° may be determined (S209). If not, the value of H may be increased by 1° (S210), and the method proceeds to S202 where the value of V1 is set. If so (H=360°), the critical values of S1 on all H may be decided (S215).

Returning to S207, if overflow is not generated, whether the value of V is 1 may be determined (S211). If the value of V is not 1, the value of V may be increased by Vs (S214). The method, then, proceeds to S206 where synthesis image signals Vrb, Vgb, and Vbb are calculated. If the value of V is 1, whether a value of S1 is 1 may be determined (S212). If the value of S1 is not 1, the method proceeds to S204 where the value of S1 is increased by Ss. If the value of S1 is 1, the critical value of S1 may be determined as 1 (S213), and whether a value of H is 360° may be determined (S209).

As described above, the critical values of S1 on all H may be decided through operation 2.

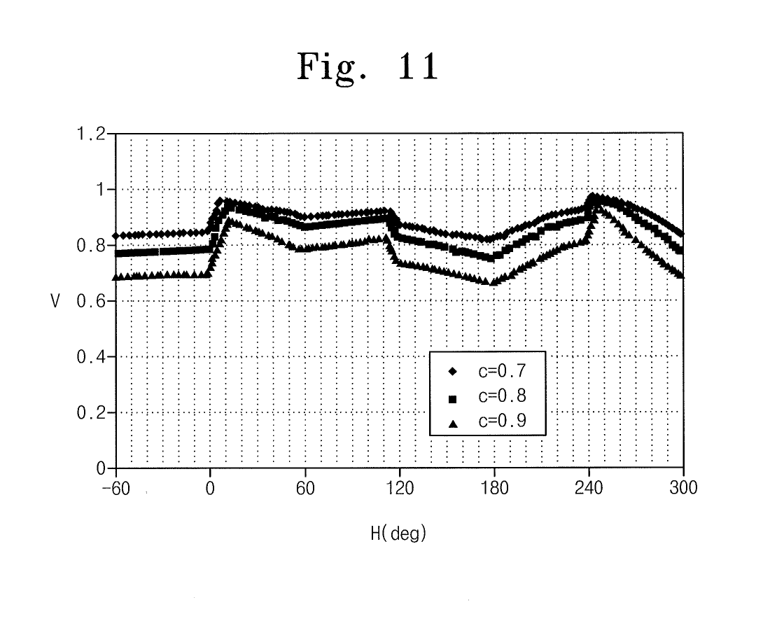

An embodiment based on the critical value(s) obtained according to the above-described operations will now be described. In this embodiment, the critical values are described in the event that a wide color gamut is UHDTV and a narrow color gamut is Adobe RGB. A result as illustrated in FIG. 11 may be obtained as the critical value of S1 when V1 is 1 regardless of hue H. Setting Ss=Vs may be Ss=Vs= 1/256. Also, a relationship between S and α may be set using a linear function, and S1 may be varied by a value of c.

As described above, by determining S1, the value of α may be determined to be more than 0, until the critical point where overflow is generated. As a result, it is possible to perform color conversion into a wide color gamut more effectively without generation of overflow.

Also, in one embodiment, the maximum value may be obtained as 1 until the critical values of V1 and S1 are obtained. However, in another embodiment, the maximum value may not be limited to 1. For example, the maximum value may be increased without limitation until overflow is generated. Also, in exemplary embodiments, V2 may be (V1−0.1). In other embodiments, V2 may be another value less than V1.

An image processing method according to the second embodiment may be implemented as a program executed by a device such as a computer, a central processing unit (CPU) embedded in a host device, or another type of processing circuit. The related program may be stored in a computer readable storage medium, and may be provided through a communication network.

### Third Embodiment

A third embodiment relates to determining a blend coefficient α using image signals Vr′, Vg′, and Vb′ after conversion, in order to solve overflow without calculation of H, S, and V values.

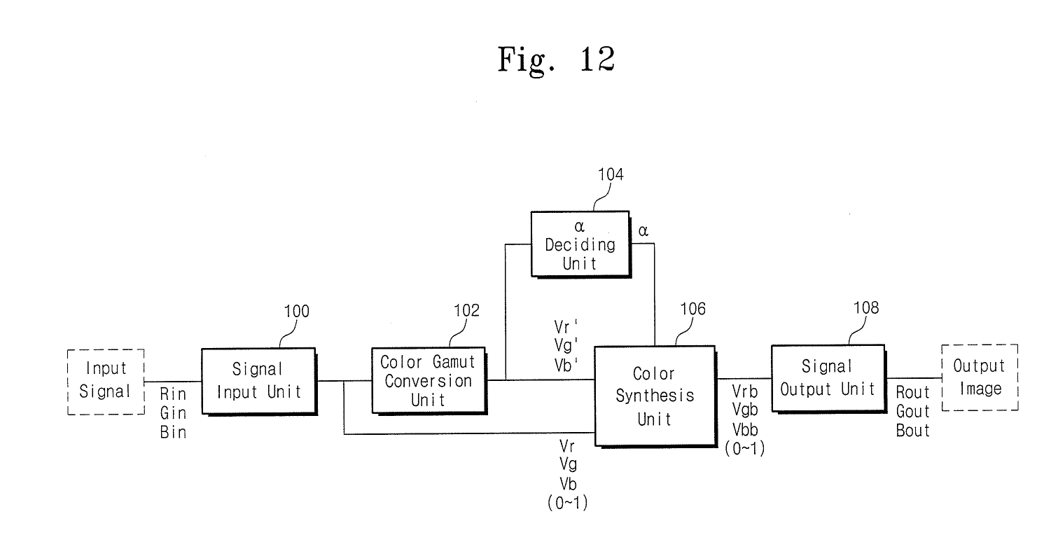

FIG. 12 illustrates an image processing device according to the third embodiment. The image processing device may include a signal input unit 100, a color gamut conversion unit 102, a blend coefficient deciding unit (α deciding unit) 110, a color synthesis unit 106, and a signal output unit 108.

The signal input unit 100 may receive a signal (e.g., input signals Rin, Gin, and Bin) indicating an image. The signal input unit 100 may standardize the input signals Rin, Gin, and Bin between 0 and 1. The signal input unit 100 may perform power conversion on the standardized signals to generate linear image data Vr, Vg, and Vb.

The color gamut conversion unit 102 may convert the image signals Vr, Vg, and Vb generated by the signal input unit 100 into an image signal of a narrow color gamut using a conversion matrix. For example, there is illustrated an embodiment associated with conversion from UHDTV color gamut to an Adobe RGB color gamut. However, a conversion between one or more different standards may be performed in alternative embodiments.

The color gamut conversion unit 102 may perform a calculation for expression of an image having a wide color gamut standards in a narrow color gamut image output device using a conversion matrix. The color gamut conversion unit 102 may generate image signals Vr′, Vg′, and Vb′ as a conversion result.

The blend coefficient deciding unit 110 may determine a blend coefficient α based on converted image signals Vr′, Vg′, and Vb′. The blend coefficient α may define a synthesis ratio of image signals Vr, Vg, and Vb and image signals Vr′, Vg′, and Vb′ synthesized by the color synthesis unit 106. For example, in the synthesis ratio, if the blend coefficient α is 1, the image signals Vr′, Vg′, and Vb′ may be 100%. If the blend coefficient α is 0, the image signals Vr, Vg, and Vb may be 100%.

The blend coefficient deciding unit 110 may directly determine generation of an overflow condition for second image signals Vr′, Vg′, and Vb′. The blend coefficient deciding unit 110 may set a first blend coefficient when overflow is generated, and a second blend coefficient that is greater than the first blend coefficient or less than 1 when overflow is not generated.

The color synthesis unit 106 may synthesize image signals Vr, Vg, and Vb generated by signal input unit 100 and image signals Vr′, Vg′, and Vb′ generated by color gamut conversion unit 102 using a synthesis ratio determined according to the blend coefficient α decided by the blend coefficient deciding unit 110. Here, a narrow color gamut expression may correspond to a condition where overflow of the image signals Vr′, Vg′, and Vb′ is generated. Blending of a wide color gamut and a narrow color gamut may correspond to a condition where overflow is not generated. The color synthesis unit 106 may generate synthesized image signals Vrb, Vgb, and Vbb.

The signal output unit 108 may perform power conversion on image signals Vrb, Vgb, and Vbb, after synthesis, to generate output signals Rin, Gin, and Bin. For example, Rout, Gout, and Bout having the number of bits required may be generated through a power of 1/2.2. The output signals Rout, Gout, and Bout may be output to an image output device such as a display, a projector, a printer, etc.

With the image processing device, it is unnecessary to calculate H, S, and V values from R, G, and B data of an input signal. Thus, the size of the image processing device may be scaled down, and calculation time may be shortened.

An image processing method according to the third embodiment will now be described. First, standardized input signals Rin, Gin, and Bin between 0 and 1 may be performed according to equation (1) in the first embodiment. Linear image signals Vr, Vg, and Vb may be generated by power conversion on a signal after standardizing.

Then, image signals Vr′, Vg′, and Vb′, after color conversion, may be calculated from image signals Vr, Vg, and Vb. A conversion matrix [Mc] for expression of a wide color gamut of a narrow color gamut image output device may be as expressed by equations (2) and (3) according to the first embodiment.

Synthesis image signals Vrb, Vgb, and Vbb may be generated by blending image signals Vr′, Vg′, and Vb′ and image signals Vr, Vg, and Vb. Synthesis image signals Vrb, Vgb, and Vbb may be obtained using equations (4) to (6) according to the first embodiment. The blend coefficient α will now be more fully described.

Synthesis image signals Vrb, Vgb, and Vbb may be converted into output signals Rout, Gout, and Bout according a required bit number through power conversion. For example, the output signals Rout, Gout, and Bout according a required bit number may be generated through a power of 2.2. In an 8-bit case, equation (7) according to the first embodiment may be used.

The blend coefficient α may be determined based on image signals Vr′, Vg′, and Vb′ after conversion. To find a condition where synthesis image signals Vrb, Vgb, and Vbb are overflowed, first, a search is performed to determine a condition where image signals Vr′, Vg′, and Vb′ are overflowed. In exemplary embodiments, it is possible to obtain image signals Vr′, Vg′, and Vb′ easily without calculation of H, S, and V values.

Signals Vr″, Vg″, and Vb″ may be calculated from image signals Vr′, Vg′, and Vb′. First, a relationship between image signals Vr′, Vg′, and Vb′ and signals Vr″, Vg″, and Vb″ may be defined by equation (18).

Vi″=Vi′ (0≦Vi′≦1)

Vi″=0 (Vi′<0)

Vi″=1 (Vi′>1)

i=r, g, b (18)

A minimum value may be obtained by comparing Vi″ obtained from equation (18) and (1−Vi″) (Min(Vi″, 1−Vi″)(i=r, g, b)). Since Vi″ is 0, 1, more than 0 or less than 1 by equation (18), a value obtained by comparing Vi″ and (1−Vi″) may be 0, 0.5, or a value between 0 and 0.5.

Here, Min(Vi″, 1−Vi″)=0 may be a condition where image signals Vr′, Vg′, and Vb′ are overflowed. A relationship between Min(Vi″, 1−Vi″) and a blend coefficient α may be defined as follows.

(1) Min(Vi″, 1−Vi″)=0: α=0 (narrow color gamut)

(2) Min(Vi″, 1−Vi″)=0.5(Max.): α=1 (color conversion into a wide color gamut)

(3) Min(Vi″, 1−Vi″)=0˜0.5: α=0˜1(blending of a wide color gamut and a narrow color gamut)

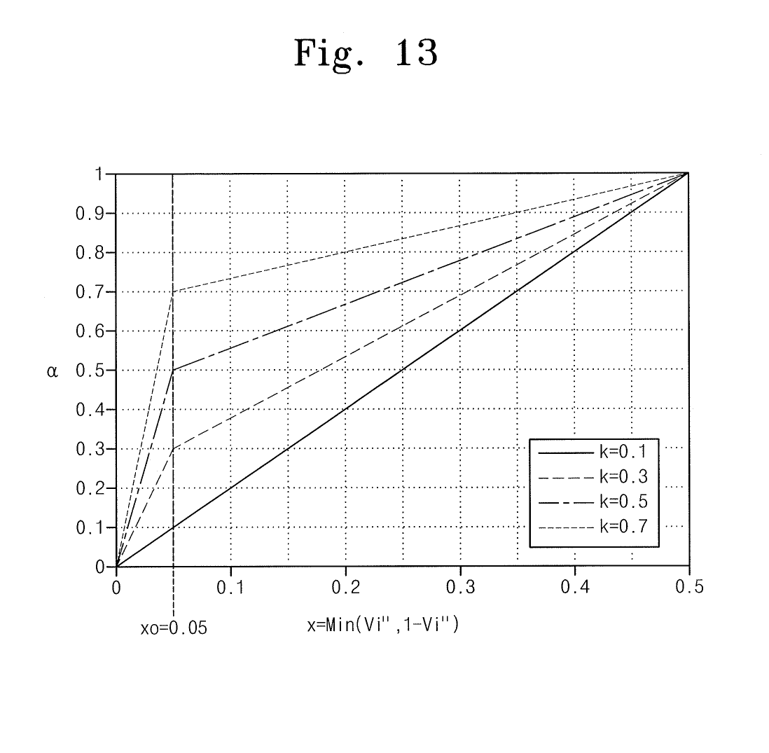

As understood from equation (19) and FIG. 13, a relationship between Min(Vi″, 1−Vi″) and blend coefficient α may be set using a knee function to adjust a blend level by a parameter k. Here, a parameter k may be a value of α when xo=0.05. The larger the value of k, the stronger a level of conversion into a wide color gamut.

$$x = Min ( {Vi}^{″} , 1 - {Vi}^{″} ) \\ i = r , g , b \\ x < x o \text{:} α = \frac{k}{xo} x \\ x \geq xo \text{:} α = k + \frac{( 1 - k )}{( 0.5 - xo )} ( x - xo ) \qquad ( 19 )$$

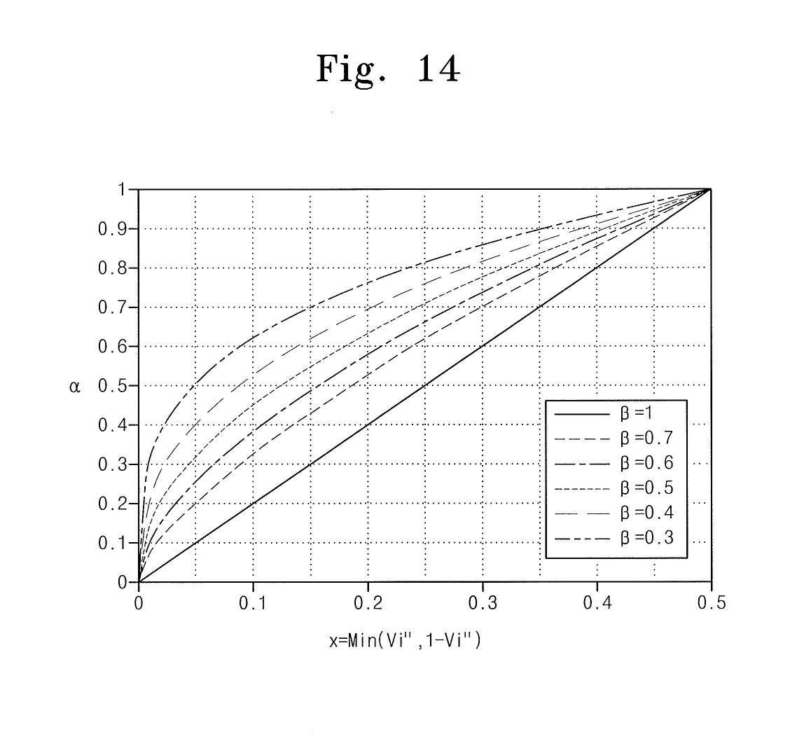

As understood from equation (20) and FIG. 14, a relationship between Min(Vi″, 1−Vi″) and blend coefficient α may be set using a exponential function to adjust a blend level by a parameter β. As understood from equation (20), a smaller value for parameter β may be understood to mean that color conversion into a wide color gamut is strong.

α=(2x)^{β}

(x=Min(Vi″, 1−Vi″), i=r, g, b) (20)

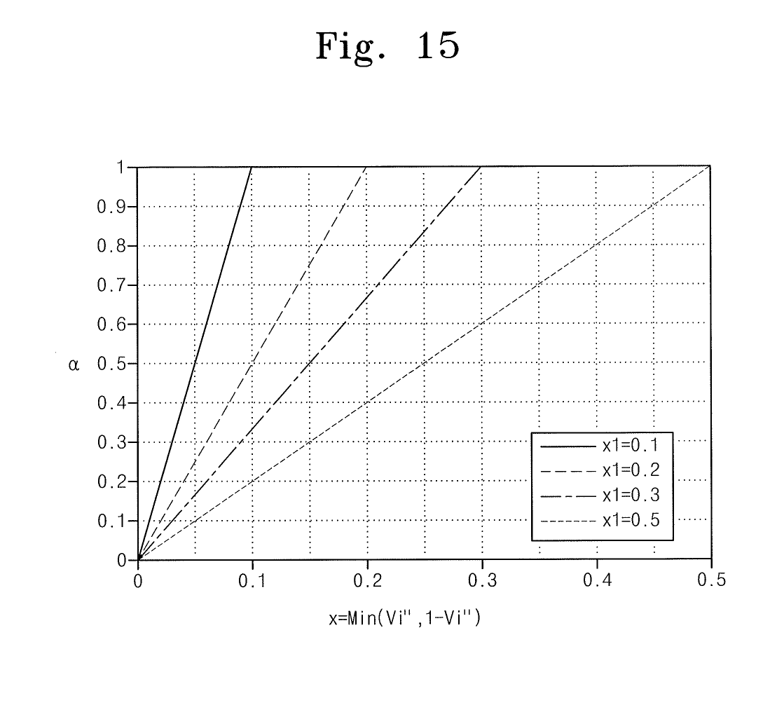

Also, as understood from equation (21) and FIG. 15, a relationship between Min(Vi″, 1−Vi″) and blend coefficient α may be set using a linear function to adjust a blend level by a parameter x1. As understood from equation (21), a smaller value for parameter x1 may be understood to mean that color conversion into a wide color gamut is strong.

$$x < x 1 \text{:} α = \frac{x}{x 1} \\ x \geq x 1 \text{:} α = 1 \qquad ( 21 )$$

Here, x1 may be x=Min(Vi″, 1−Vi″) where α=1. In other embodiments, a sigmoid function may be used instead of a linear function as shown in equation (21) and FIG. 15.

In this embodiment, it may be unnecessary to calculate H, S, and V values from R, G, and B data of an input signal. Thus, the size of a corresponding image processing device may be scaled down, and calculation time may be shortened.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An image processing device, comprising:
a signal input unit configured to convert an input signal indicating an image to a first image signal of a first color gamut, the first image signal being linear;
a color gamut conversion unit configured to convert a second color gamut to a second image signal for expression in an image output device having the first color gamut, the second color gamut being wider than the first color gamut;
a blend coefficient deciding unit configured to determine a blend coefficient for defining a synthesis ratio of the first image signal and the second image signal based on a value V and a saturation S obtained from the input signal; and
a color synthesis unit configured to synthesize the first and second image signals using a ratio based on the blend coefficient to generate a synthesis image signal,
wherein the blend coefficient deciding unit:
performs inverse conversion on the second image signal corresponding to a boundary of a color gamut;
obtains a boundary value for value V and a boundary value for saturation S corresponding to a non-overflow condition, wherein an overflow condition corresponds to a state where the synthesis image signal is not included in a range between 0 to 1;
determines a first blend coefficient when the value V is more than the boundary value for V or the saturation is more than the boundary value for S; and
determines a second blend coefficient when the value V is less than the boundary value of V and the saturation is less than the boundary value for S, the second blend coefficient being greater than the first blend coefficient and less than 1.

2. The device as claimed in claim 1, wherein the second blend coefficient varies within a range between 0 and 1 based on a linear function, an exponential function, or a sigmoid function according to the value of value V or saturation S.

3. An image processing device, comprising:
a signal input unit configured to convert an input signal indicating an image to a first image signal of a first color gamut, the first image signal being linear;
a color gamut conversion unit configured to convert a second color gamut to a second image signal for expression in an image output device having the first color gamut, the second color gamut being wider than the first color gamut;
a blend coefficient deciding unit configured to determine a blend coefficient for defining a synthesis ratio of the first image signal and the second image signal; and
a color synthesis unit configured to synthesize the first and second image signals according to a ratio based on the blend coefficient to generate a synthesis image signal, wherein the blend coefficient deciding unit:
determines an overflow condition directly from the second image signal,
determines a first blend coefficient when the overflow condition is generated, and
determines a second blend coefficient which is greater than the first blend coefficient and less than 1 when the overflow condition is not generated.

4. The device as claimed in claim 3, wherein:
the second blend coefficient varies in a range between 0 and 1 when the synthesis image signal has a value corresponding to a non-overflow condition, and
the second blend coefficient varying in the range between 0 and 1 based on a knee function, a linear function, a exponential function, or a sigmoid function according to a V value or a saturation S.

5. The device as claimed in claim 4, wherein the first blend coefficient is determined such that the synthesis image signal becomes the first image signal.

6. The device as claimed in claim 4, wherein the second blend coefficient is determined such that the synthesis image signal becomes the second image signal or corresponds to a result obtained by blending the first and second image signals.

7. An image processing method, comprising:
converting an input signal indicating an image to a first image signal of a first color gamut, the first image signal being linear;
converting a second color gamut to a second image signal for expression in an image output device having the first color gamut, the second color gamut being wider than the first color gamut;
determining a blend coefficient for defining a synthesis ratio of the first image signal and second image signal based on a value V and a saturation S obtained from the input signal; and
synthesizing the first and second image signals using a ratio based on the blend coefficient to generate a synthesis image signal,
wherein the determining the blend coefficient comprises:
performing inverse conversion from the first image signal to the second image signal corresponding to a boundary of a color gamut;
obtaining a first boundary value of V and a first boundary value of S corresponding to a non-overflow condition, an overflow condition indicating a state where the synthesis image signal is not included in a range between 0 to 1;
determining a first blend coefficient when value V is greater than the first boundary value of V or saturation S is greater than the first boundary value of S; and
determining a second blend coefficient when value V is less than the first boundary value of V and saturation is less than the first boundary value S, the second blend coefficient being greater than the first blend coefficient and less than 1.

8. The method as claimed in claim 7, wherein:
determining the blend coefficient includes determining a second boundary value for V and a second boundary value for S;
determining the second boundary value for V includes:
setting the first boundary value for V to a predetermined value, and setting the first boundary value of S to an initial saturation boundary value for each hue varied between 0° and 360°;
calculating a second synthesis image signal using the first blend coefficient and second blend coefficient, the second synthesis image signal calculated by varying V from 0 to 1 at each value boundary, an initial boundary value of V being increased by a constant interval;
setting a boundary value for V immediately before overflow to the second value boundary value, when the second synthesis image signal is determined to corresponding to an overflow condition; and
setting a value of 1 to the second boundary value of V when the second synthesis image signal corresponds to a non-overflow condition; and
determining the second boundary value for S includes:
setting the second boundary value for V to a predetermined value and the first boundary value for S to an initial saturation boundary value for each hue varied between 0° and 360°;
calculating a third synthesis image signal using the first blend coefficient and the second blend coefficient, the third synthesis image signal calculated by varying a value from 0 to 1 at each boundary S, an initial boundary value for S being increased by a constant interval;
setting a boundary value for S immediately before overflow to the second boundary value for S when the third synthesis image signal is determined to correspond to an overflow condition; and
setting a value of 1 to the second boundary value of S when the third synthesis image signal is determined to correspond to a non-overflow condition.

9. An image processing method comprising:
converting an input signal indicating an image to a first image signal of a first color gamut, the first image signal being linear;
converting a second color gamut to a second image signal for expression in an image output device having the first color gamut, the second color gamut wider than the first color gamut;
determining a blend coefficient for defining a synthesis ratio of the first image signal and the second image signal; and
synthesizing the first and second image signals using a ratio based on the blend coefficient to generate a synthesis image signal,
wherein the determining the blend coefficient includes:
determining an overflow condition directly from the second image signal,
determining a first blend coefficient corresponding to an overflow condition, and
determining a second blend coefficient corresponding to a non-overflow condition, the second blend coefficient being more than the first blend coefficient and less than 1.

10. An image processing method, comprising:
converting an input signal to a first image signal of a first color gamut;
converting a second color gamut to a second image signal for expression in an image output device having the first color gamut;
determining a blend coefficient for defining a synthesis ratio of the first and second image signals, the blend coefficient based on a value V and a saturation S obtained from the input signal; and
synthesizing the first and second image signals using a ratio based on the blend coefficient to generate a synthesis image signal.

11. The method as claimed in claim 10, wherein determining the blend coefficient comprises:
performing an inverse conversion from the first image signal to the second image signal corresponding to a boundary of a color gamut wider than the first color gamut;
obtaining a first boundary value of V and a first boundary value of S corresponding to a non-overflow condition;
determining the blend coefficient as a first blend coefficient when value V is greater than the first boundary value of V or saturation S is greater than the first boundary value of S; and
determining the blend coefficient as a second blend coefficient when value V is less than the first boundary value of V and saturation is less than the first boundary value S, the second blend coefficient being greater than the first blend coefficient and less than 1.

12. The method as claimed in claim 11, wherein the wide color gamut corresponds to the second color gamut.

13. The method as claimed in claim 10, wherein the first image signal is linear.

14. The method as claimed in claim 10, wherein the second color gamut is wider than the first color gamut.

15. The method as claimed in claim 10, wherein the overflow condition corresponds to a state where the synthesis image signal is not included in a predetermined range.

16. The method as claimed in claim 15, wherein the predetermined range includes between 0 and 1.

17. The method as claimed in claim 10, wherein determining the blend coefficient includes:
determining an overflow condition from the second image signal,
determining the blend coefficient to be a first blend coefficient corresponding to an overflow condition, and
determining the blend coefficient to be a second blend coefficient corresponding to a non-overflow condition, the second blend coefficient being greater than the first blend coefficient and less than a predetermined value.

18. The method as claimed in claim 17, wherein the predetermined value is 1.

19. The method as claimed in claim 10, wherein:
determining the blend coefficient includes determining a second boundary value for V and a second boundary value for S,
wherein determining the second boundary value for V includes:
setting the first boundary value for V to a predetermined value, and setting the first boundary value of S to an initial saturation boundary value for each hue varied between 0° and 360°;
calculating a second synthesis image signal using the first blend coefficient and second blend coefficient, the second synthesis image signal calculated by varying V from 0 to 1 at each value boundary, an initial boundary value of V being increased by a constant interval;
setting a boundary value for V immediately before overflow to the second value boundary value, when the second synthesis image signal is determined to corresponding to an overflow condition; and
setting a value of 1 to the second boundary value of V when the second synthesis image signal corresponds to a non-overflow condition.

20. The method as claimed in claim 19, wherein determining the second boundary value for S includes:
setting the second boundary value for V to a predetermined value and the first boundary value for S to an initial saturation boundary value for each hue varied between 0° and 360°;
calculating a third synthesis image signal using the first blend coefficient and the second blend coefficient, the third synthesis image signal calculated by varying a value from 0 to 1 at each boundary S, an initial boundary value for S being increased by a constant interval;
setting a boundary value for S immediately before overflow to the second boundary value for S when the third synthesis image signal is determined to correspond to an overflow condition; and
setting a value of 1 to the second boundary value of S when the third synthesis image signal is determined to correspond to a non-overflow condition.
